(19) United States
(12) Patent Application Publication
(10) Pub. No.: US 2019/0276288 A1
(43) Pub. Date: Sep. 12, 2019

(54) POWERED ROLLING PRY BAR FOR REPOSITIONING HEAVY LOADS

(71) Applicant: Government of the United States, as represented by the Secretary of the Air Force, ROME, NY (US)

(72) Inventor: MARK HERRON LINDERMAN, Rome, NY (US)

(21) Appl. No.: 15/988,235

(22) Filed: May 24, 2018

Related U.S. Application Data
(60) Provisional application No. 62/640,256, filed on Mar. 8, 2018.

(51) Int. Cl. B66F 9/065; B66F 15/00

(52) U.S. Cl. CPC B66F 9/065; B66F 15/00

(57) ABSTRACT

An apparatus and system for repositioning heavy loads. Apparatus features an operator handle capable of positioning a lifting tongue under a load to be repositioned. The apparatus further features a set of motor driven wheels that engage the floor or other surface with the aid of friction or other traction means to propel the load forward or backward. Downward pressure on the operator handle while the lifting tongue is positioned under the load increase the motor driven wheels traction. The system further features rolling elements integral to the floor to further aid repositioning of the load as well as mechanical engagement means between the motor driven wheels and the floor where adequate friction between the same is not possible. The apparatus further features an addition set of unpowered wheels that may be alternately repositioned for engagement with the floor so as to lift the motor driven wheels out of contact with the floor to aid in orienting the apparatus with the load.

### CROSS REFERENCE TO RELATED APPLICATIONS

This application claims the benefit under 35 U.S.C. § 119(e) of U.S. Provisional Patent Application Ser. No. 62/640,256 filed on Mar. 8, 2018 the entire content of which is incorporated herein by reference.

### STATEMENT OF GOVERNMENT INTEREST

The invention described herein may be manufactured, used and licensed by or for the Government of the United States for all governmental purposes without the payment of any royalty.

### FIELD OF THE INVENTION

The present disclosure relates generally to an apparatus to assist human operators in repositioning heavy loads, such as pallets, without lifting them.

### BACKGROUND OF THE INVENTION

Cargo movers such as airmen positioning pallets of material on cargo airplanes, often must reposition heavy loads without the assistance of vehicles or other heavy machinery. Over time, the strain of repositioning such loads results in high rates of musculoskeletal injuries. While movement aids such roller bearing strips in the floor of the cargo vehicle or loads that are on wheels may reduce the force required to reposition a load, they do not eliminate the burden entirely. In addition, in actual harsh field conditions, these bearings or wheels may not operate as efficiently as intended, placing greater burden on the human operator.

Some aircraft are equipped with winches and cabling to assist the human operator placing the load into an aircraft, but such devices are understood to be underutilized because they are inconvenient, require extensive safety checks, or simply lack the ability to maneuver loads to the particular desired position. Other means such as well-known pallet movers may not be available, may require excessive maneuver space, may damage the floor of a conveyance, or may not be able to manipulate a pallet without holes to accept the forks of the pallet mover.

### OBJECTS AND SUMMARY OF THE INVENTION

The foregoing problems and other shortcomings, drawbacks, and challenges associated with repositioning heavy loads are overcome by the embodiments of the invention described herein. While the invention will be described in connection with certain embodiments, it is understood that it is not limited to these embodiments. To the contrary, the present invention includes all alternatives, modifications and equivalents within the scope of the embodiments disclosed.

Therefore, in accordance with an embodiment of the present disclosure, an apparatus to reposition heavy loads is provided. The apparatus may include a powered rolling element that provides the horizontal force to push or pull a heavy load. To increase the downward force on the rolling element, a tongue on one side of the rolling element and a longer handle or foot plate on another side may provide leverage. The tongue may extend beyond the rolling element and be positioned under a portion of the heavy load, for example under a protrusion of a pallet or under the pallet itself. Downward force on the handle or foot plate will cause upward force on the tongue which is pinned beneath the weight of the load, whereby the rolling element acts as a fulcrum between the handle and the foot or tongue. The amount of pressure increase on the rolling element will be in proportion to the distance from the rolling element to the downward force on the handle and the distance from the rolling element to the point of contact on the load. The increase in pressure on the rolling element further aids traction when the rolling element is powered by a motive force.

It is important to note that such force is not necessarily applied with the intent of lifting the load, as is the case with many prior means of repositioning a load, but primarily to increase the downward force on the rolling element that may rely upon surface friction or other engagement mechanism (e.g., a gear rack) to generate effective horizontal motion and force. If the external horizontal force required to impart motion to move the load is much less in relation to the downward force the load exerts (in other words, the weight of the load), then it is not necessary to lift the load to move it, rather it is only necessary to provide sufficient downward force on the rolling element so that it does not slip while attempting to generate an external horizontal force sufficient to move the load. If the rolling element relies solely upon friction to generate horizontal force the horizontal force produced by the rolling element is limited to no more than the downward force on the rolling element. One feature of the present invention increases this downward force while power is applied to the rolling element.

In embodiments of the invention having a protruding tongue, the tongue may engage a notch or hole or some other means of the load to apply a pulling force to the load without disengaging from the load, the apparatus may additionally reposition the load by pulling it in addition to pushing it.

It is an object of the present invention to provide an apparatus and system to reposition heavy loads through the employment of a mechanized means.

It is a further object of the present invention to provide an apparatus and system to reposition heavy loads that is portable and independent of the host cargo vessel.

It is yet a further object of the present invention to provide an apparatus and system to reposition heavy loads that can be rapidly reoriented to the load and from one load to the next load.

According to a fundamental embodiment of the present invention, an apparatus for repositioning heavy loads comprises a lever having a first lever section of predetermined length joined to a second lever section of predetermined length, where the first lever section and the second lever section are joined at an angle; a rolling element joined to the lever and about which the lever pivots; a motor mounted to the lever; and a drive to convert torque from the motor to the rolling element so as to impart rotation to the rolling element.

According to an alternate embodiment of the present invention, an apparatus for repositioning heavy loads comprises a lever having a first lever section of predetermined length joined to a second lever section of predetermined length, wherein the first lever section and the second lever section are joined at an angle; a first rolling element joined to the lever and about which the lever pivots; a second rolling element joined to the lever, where the second rolling element freely rotates; a motor mounted to the lever; and a drive to convert torque from the motor to the first rolling element so as to impart rotation to the first rolling element.

According to a systematized embodiment of the present invention, a system for repositioning heavy loads comprises a lever having a first lever section of predetermined length joined to a second lever section of predetermined length, wherein the first lever section and the second lever section are joined at an angle; a rolling element joined to the lever and about which the lever pivots; a motor mounted to the lever; a drive to convert torque from the motor to the rolling element so as to impart rotation to the rolling element; and a floor, wherein the floor further comprises a first surface feature upon which the rolling element engages; and a second surface feature upon which the load traverses.

Briefly stated, the present invention provides apparatus and system for repositioning heavy loads. Apparatus features an operator handle capable for positioning a lifting tongue under a load to be repositioned. The apparatus further features a set of motor-driven wheels that engage the floor or other surface with the aid of friction or other traction means to propel the load forward or backward. Downward pressure on the operator handle while the lifting tongue is positioned under the load increases the motor-driven wheels' traction. The system further features rolling elements integral to the floor to further aid repositioning of the load as well as mechanical engagement means between the motor driven wheels and the floor where adequate friction between the same is not possible. The apparatus may further comprise an additional set of unpowered wheels, bearings, casters or the like that may be alternately repositioned for engagement with the floor so as to lift the motor driven wheels out of contact with the floor to aid in orienting the apparatus with the load.

### BRIEF DESCRIPTION OF THE DRAWINGS

The accompanying drawings provide visual representations which will be used to more fully describe various representative embodiments. They can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals may identify corresponding elements.

FIG. 1 is a side-facing depiction of an embodiment of the present invention employing a large diameter rolling element with a protruding tongue and a transverse-mounted motor.

FIG. 2 is a side-facing depiction of an embodiment of the present invention employing a small diameter rolling element with a top-mounted tongue and a transverse-mounted motor.

FIG. 3 is a front-facing depiction of an embodiment of the present invention employing a large diameter rolling element with a protruding tongue and a transverse-mounted motor.

FIG. 4 is a side-facing depiction of an embodiment of the present invention employing depressible positioning wheels.

FIG. 5 is a front-facing depiction of an embodiment of the present invention employing depressible positioning wheels.

FIG. 6 is a side-facing depiction of an embodiment of the present invention employing a large diameter rolling element with a protruding tongue and a transverse-mounted motor and a foot pedal for operator-applied downward force rather than a handle.

### DETAILED DESCRIPTION OF THE INVENTION

The various methods, systems, apparatus, and devices described herein generally provide for improved ability to reposition heavy loads. Embodiments of the present invention are directed to a powered device that leverages the weight of the object to be moved to create sufficient downward force to permit application of horizontal force sufficient to push or pull the load to be repositioned.

While this invention is amenable to being embodied in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals may be used to describe the same, similar or corresponding parts in the several views of the drawings.

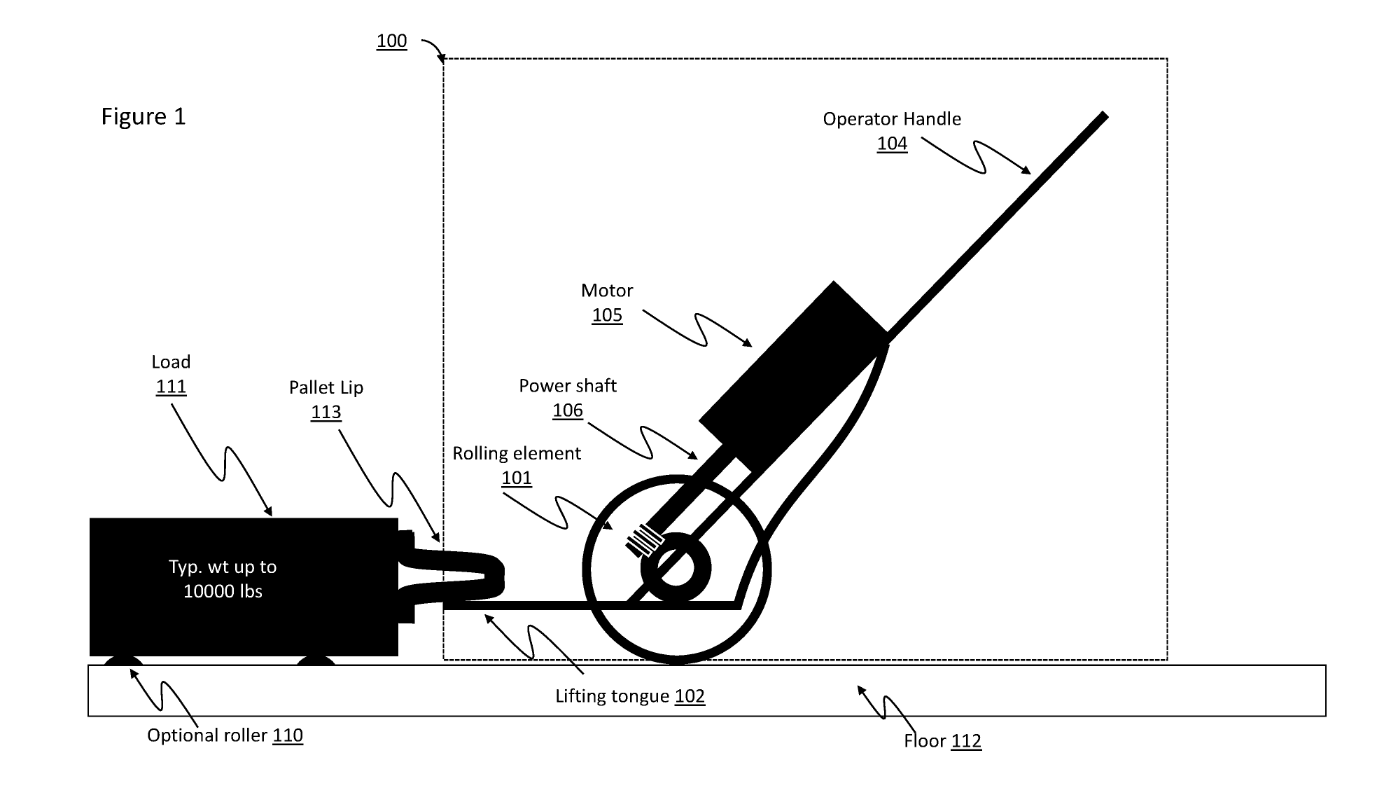

Referring now to the drawings, FIG. 1 is a depiction of an apparatus 100 for repositioning heavy loads. The apparatus 100 is configured to push a load 111 resting upon rollers 110 embedded in the floor 112. The apparatus 100 comprises a lifting tongue 102 that is pressed against the load 111 pallet lip 113 and that protrudes beyond the rolling element 101, an operator handle 104, a motor 105, a rolling element 101, and a power shaft 106 that applies motive force from the motor 105 to the rolling element 101. As depicted, the handle or lever, these terms being used interchangeably, 104 is joined to the lifting tongue 102 at an obtuse angle. It is understood that this angle is notional and that any angle of joinder may be employed. The relatively short distance between the rolling element 101 and the lifting tongue 102 at its point of contact with the pallet lip 113, in proportion to the relatively greater distance from the rolling element 102 to the point of the operator's downward force on the operator handle 104, results in a mechanical advantage that increases the downward force of the rolling element 101 upon the floor 112. While a mounted motor 105 is depicted in FIG. 1, it is understood that embodiments of the present invention may employ different motor configurations and various coupling means and drive means to convert torque from the motor 105 to rotation of the rolling element 101. Additionally, while rolling element 101 as depicted relies upon wheel friction between it and the floor 112, additional features of any embodiment disclosed herein may comprise rolling elements 101 which do not rely upon friction with the floor 112, but alternatively further comprise an engagement means such as a geared rack and pinion relationship (not shown) between the rolling element 101 serving as the pinion and a floor 112 comprising a track or rail incorporating a geared rack along which the rolling element 101 having peripheral gear teeth engages and drives along. While FIG. 1 depicts a surface feature of the floor having wheels or bearings attached to the floor to reduce the force necessary to move a flat-bottomed load, an alternative load configuration may feature a wheels affixed to the load or load pallet that rolls along a flat floor.

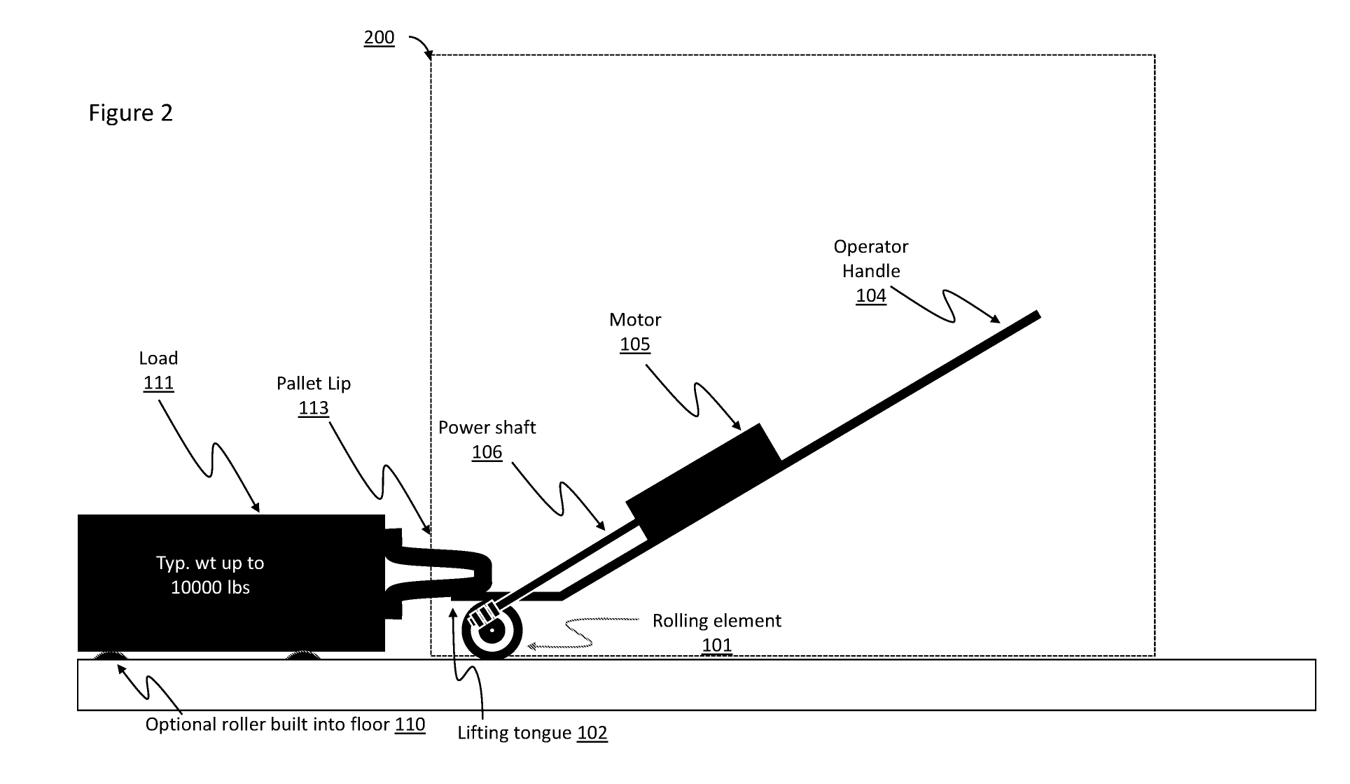

FIG. 2 is a depiction of an apparatus 200 for repositioning heavy loads configured to push a load 111 resting upon rollers 110 embedded in the floor 112. The apparatus 100 comprises a lifting tongue 102 that is pressed against the load 111 pallet lip 113 being above the rolling element 101, an operator handle 104, a motor 105, a rolling element 101, and a drive mechanism in the form of a power shaft 106 that applies motive force to the rolling element. The relatively short distance from the rolling element 101 to the lifting tongue 102 point of contact with the pallet lip 113 in proportion to the relatively greater distance from the rolling element 102 to the point of the operator's downward force on the operator handle 104 results in a mechanical advantage that increases the downward force of the rolling element 101 upon the floor 112 in proportion to the weight of the load at the pallet lip 113. The positioning of the lifting tongue above the rolling element in this embodiment increases the potential mechanical advantage that results from the operator's downward force on the operator handle 104. While a mounted motor 105 is depicted in FIG. 2, it is understood that any embodiments of the present invention may employ different motor configurations and various drive means including but not limited to couplings between the motor 105, power shaft 106 and rolling element 101 and the ability to engage and disengage the drive means from the rolling element 101.

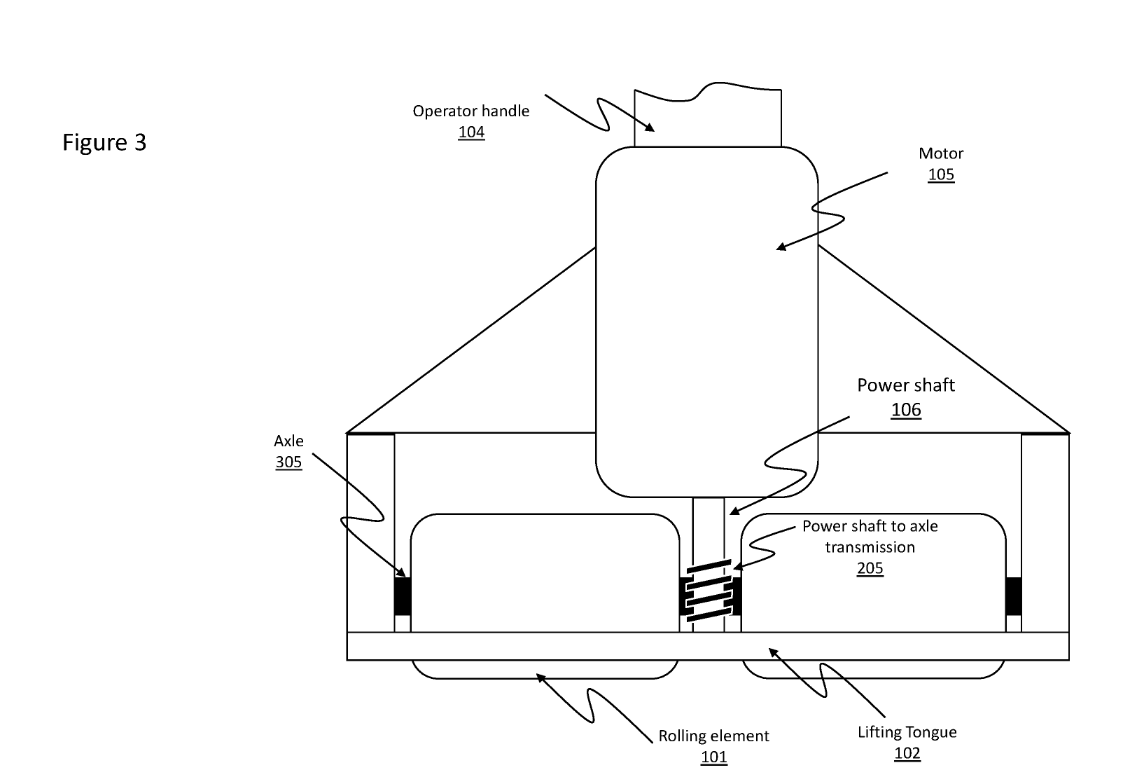

FIG. 3 is a front-facing depiction of the present invention depicting the physical relationship of the operator handle 104, the motor 105, the power shaft 106 from the motor 105 and one embodiment of a transmission means 205 to convert torque from the power shaft 106 to the axle 305 upon which rolling elements 101 revolve.

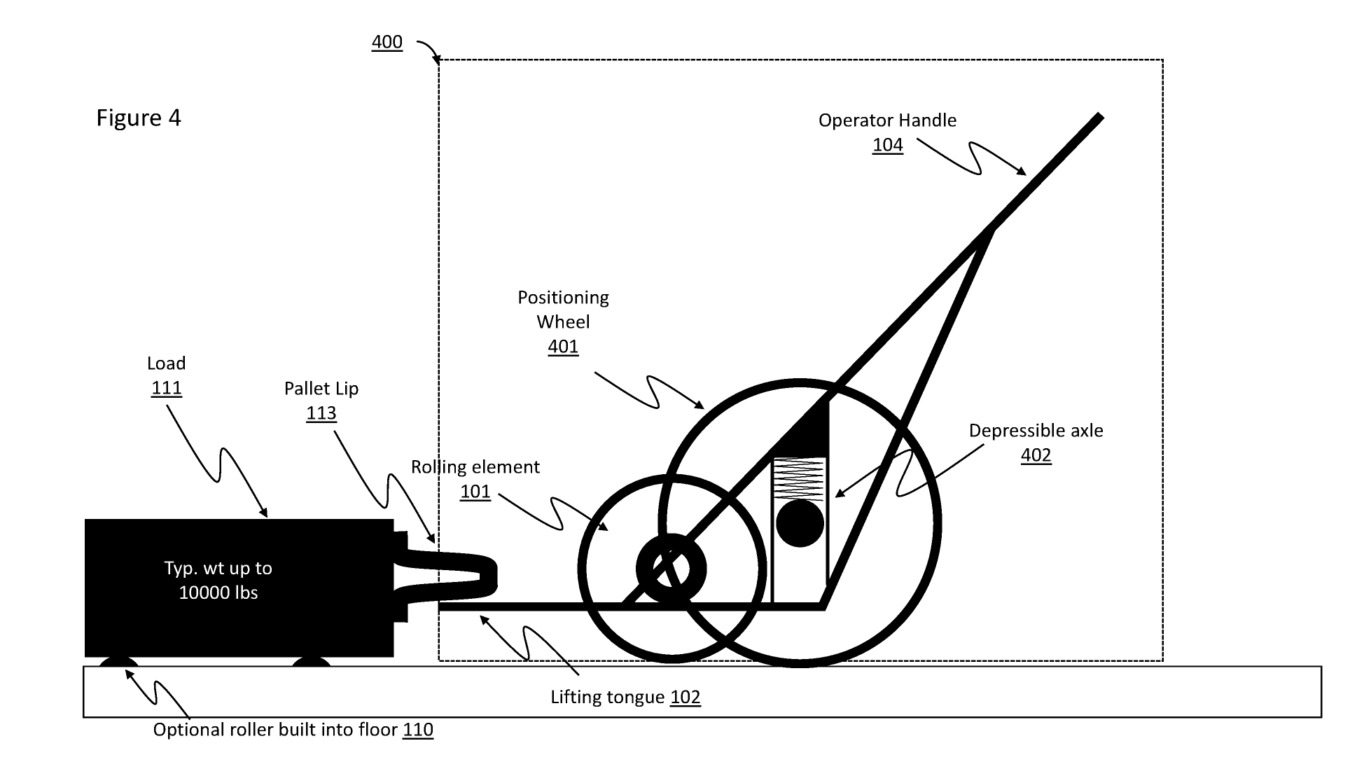

FIG. 4 is a depiction of an apparatus for repositioning heavy loads further comprising at least one pair of positioning wheels 401 mounted to a depressible axle 402 that lift the rolling element 101 off the floor when the lifting tongue 102 is not being used to increase downward force on the rolling element 101. When the lifting tongue 102 is being used to increase downward force on the rolling element 101, the depressible axle 402 of the positioning wheel 401 is relocated upwards relative to the rolling element 101 and out of contact with the floor 112 until the rolling element 101 rests in contact with the floor 112. There exist many available means to raise and lower the depressible axle 402. The purpose of the “freewheeling” positioning wheels 401 is to permit easy and rapid repositioning of the apparatus 400 considering that the rolling element 101 may not necessarily “freewheel” to position the apparatus 400 with respect to the load to be repositioned. Alternatively, instead of or in combination with the depressible axle 402 and positioning wheels 401, the rolling element 101 may be disengaged by available transmission, clutch or other coupling means from the power shaft 106 to facilitate “freewheeling” of the rolling element 106.

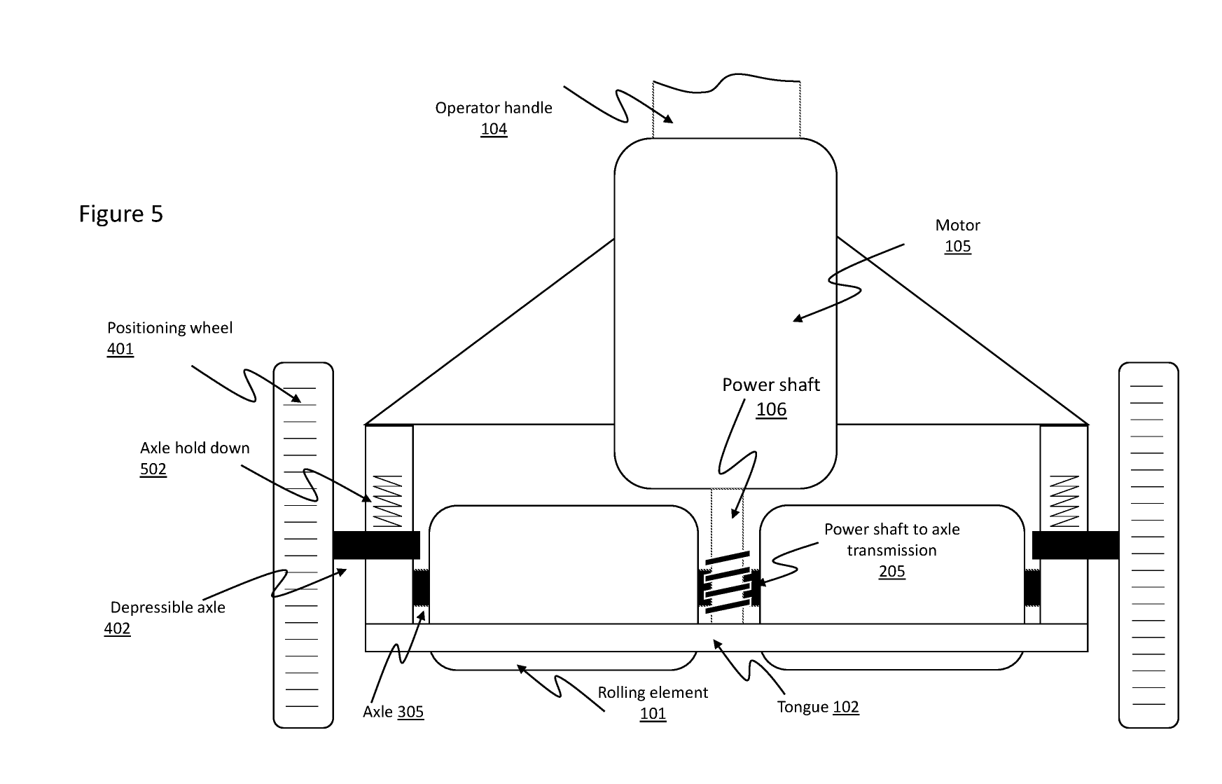

FIG. 5 is a front-facing depiction of the present invention depicting the physical relationship of the operator handle 104, the motor 105, the power shaft 106 from the motor 105 and one embodiment of a transmission means 205 to convert torque from the power shaft 106 to the axle 305 upon which rolling elements 101 revolve. Also depicted is the physical relationship of the embodiment's positioning wheel pair 401 and the depressible axle 402 they are mounted on. Axle hold down 502 maintains and/or facilitates the positioning of the depressible axle 402 in a raised or lowered state so as to place the positioning wheels 401 out of contact or in contact with the floor, respectively, and conversely, placing the rolling elements in contact or out of contact with the floor, respectively.

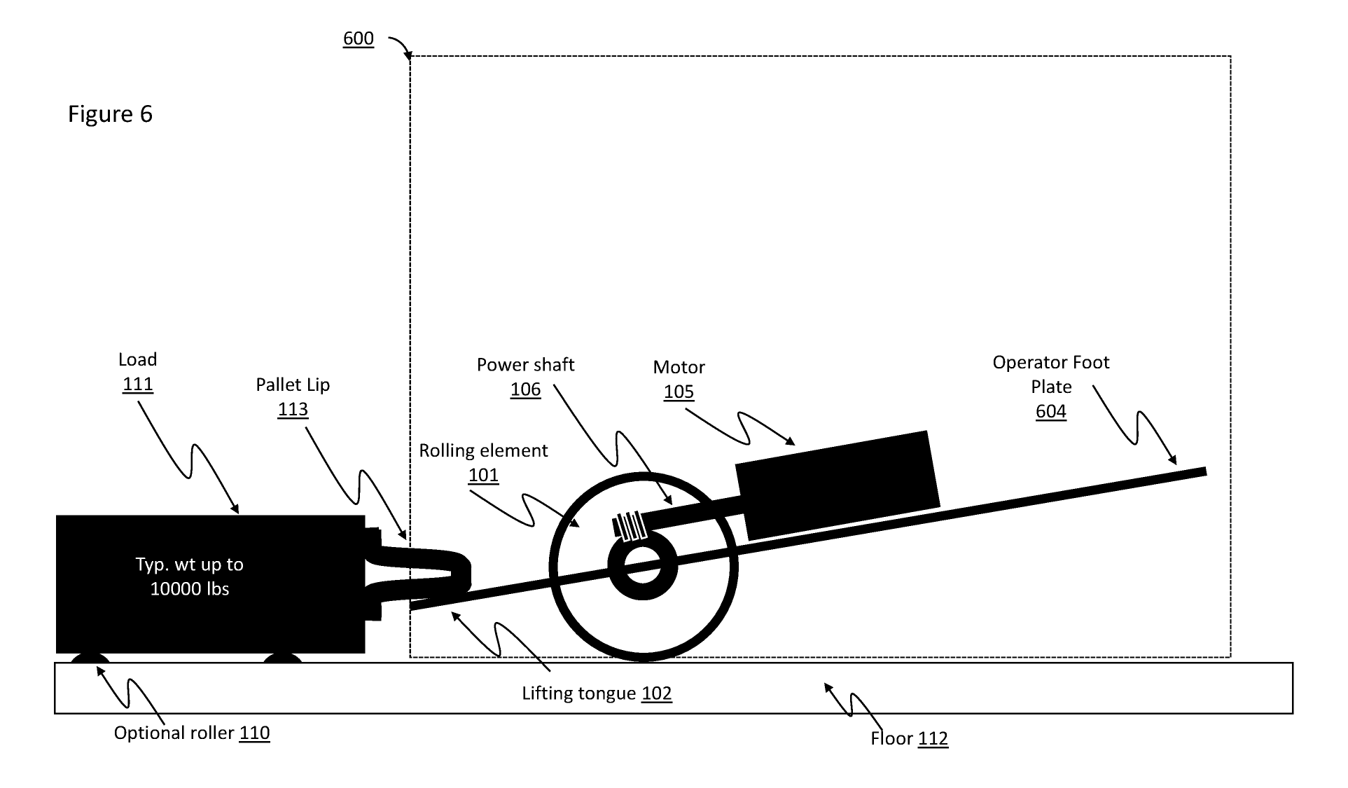

Referring now to FIG. 6 is a depiction of an apparatus 600 for repositioning heavy loads. The apparatus 600 is configured to push a load 111 resting upon rollers 110 embedded in the floor 112. Note that the present invention is equally compatible with loads that have rollers 115 attached as well as loads without rollers where the rollers 115 are integral to the floor surface 112. The apparatus 600 comprises a lifting tongue 102 that is pressed against the load 111 pallet lip 113 and that protrudes beyond the rolling element 101, an operator's foot actuated foot plate 604, a motor 105, a rolling element 101, and a power shaft 106 that applies motive force from the motor 105 to the rolling element 101. As depicted is this particular embodiment of the present invention, the foot plate 604 is joined to the lifting tongue 102 at a 180 degree angle. It is understood, however, that this angle is notional and that any angle of joinder may be employed within the scope of the present invention. The relatively short distance between the center of the rolling element 101 and the lifting tongue 102 at its point of contact with the pallet lip 113, in proportion to the relatively greater distance from the center of rolling element 102 to the point of the operator's downward force on the operator foot plate 604, results in a mechanical advantage that increases the downward force of the rolling element 101 upon the floor 112 in proportion to the weight of the load at the pallet lip 113. While a mounted motor 105 is depicted in FIG. 6, it is understood that embodiments of the present invention may employ different motor configurations and various coupling means and drive means to convert torque from the motor 105 and power shaft 106 to rotation of the rolling element 101.

Referring to FIG. 1, while rolling element 101 as depicted relies upon wheel friction between it and the floor 112, additional features of any embodiment disclosed herein may comprise rolling elements 101 which, rather than relying solely upon friction as a surface feature of the floor 112, instead or in addition employ a mechanical engagement means between the rolling elements 101 as a surface feature of the floor 112. This mechanical engagement means may include for example gears in a rack and pinion arrangement. In said arrangement, the rolling element 101 may include gears or pinions that engage a linear gear or rack that is attached to or part of the floor 112.

What is claimed is:

1. An apparatus for repositioning heavy loads, comprising:
a lever having a first lever section of predetermined length joined to a second lever section of predetermined length, wherein said first lever section and said second lever section are joined at an angle;
a rolling element joined to said lever and about which said lever pivots;
a motor mounted to said lever; and
a drive to convert torque from said motor to said rolling element so as to impart rotation to said rolling element.

2. The apparatus of claim 1, wherein said rolling element is positioned so as to impart a predetermined mechanical advantage from said first lever section to said second lever section.

3. The apparatus of claim 1, wherein said rolling element is positioned at predetermined distances from said point of joinder of said first lever section and said second lever section so as to impart a predetermined mechanical advantage from said first lever section to said second lever section.

4. The apparatus of claim 1, wherein said drive further comprises a power shaft and a coupling.

5. The apparatus of claim 1, wherein said drive further comprises a drive engagement and a drive disengagement.

6. The apparatus of claim 1, wherein the application of a downward force to said first lever section causes said second lever section to generate an upward force, said upward force being predeterminable according to the lengths of said first and second lever sections, said downward force, said angle, and the positioning of said rolling element,
wherein said angle is substantially and inclusively between 90 degrees and 225 degrees.

7. An apparatus for repositioning heavy loads, comprising:
a lever having a first lever section of predetermined length joined to a second lever section of predetermined length, wherein said first lever section and said second lever section are joined at an angle;
a first rolling element joined to said lever and about which said lever pivots;
a second rolling element joined to said lever, wherein said second rolling element freely rotates;
a motor mounted to said lever; and
a drive to convert torque from said motor to said first rolling element so as to impart rotation to said first rolling element.

8. The apparatus of claim 7, wherein said first rolling element is positioned so as to impart a predetermined mechanical advantage from said first lever section to said second lever section.

9. The apparatus of claim 7, wherein said first rolling element is positioned at predetermined distances from said point of joinder of said first lever section and said second lever section so as to impart a predetermined mechanical advantage from said first lever section to said second lever section.

10. The apparatus of claim 7, wherein said drive further comprises a power shaft and a coupling.

11. The apparatus of claim 7, wherein said drive further comprises a drive engagement and a drive disengagement.

12. The apparatus of claim 7, wherein said first rolling element remains disengaged from said floor until an operator applies downward force to said first lever section.

13. The apparatus of claim 7, wherein the application of a downward force to said first lever section causes said second lever section to generate an upward force, said upward force being predeterminable according to the lengths of said first and second lever sections, said downward force, said angle, and the positioning of said rolling element,
wherein said angle is substantially and inclusively between 90 degrees and 225 degrees.

14. A system for repositioning heavy loads, comprising:
a lever having a first lever section of predetermined length joined to a second lever section of predetermined length, wherein said first lever section and said second lever section are joined at an angle;
a rolling element joined to said lever and about which said lever pivots;
a motor mounted to said lever;
a drive to convert torque from said motor to said rolling element so as to impart rotation to said rolling element; and
a floor, wherein said floor further comprises:
a first surface feature upon which said rolling element engages; and
a second surface feature upon which said load traverses.

15. The system of claim 14, wherein said rolling element is positioned so as to impart a predetermined mechanical advantage from said first lever section to said second lever section.

16. The system of claim 14, wherein said rolling element is positioned at predetermined distances from said point of joinder of said first lever section and said second lever section so as to impart a predetermined mechanical advantage from said first lever section to said second lever section

17. The system of claim 14, wherein said drive further comprises a power shaft and a coupling.

18. The system of claim 14, wherein said drive further comprises a drive engagement and a drive disengagement.

19. The system of claim 14, wherein said first surface feature comprises a mechanical engagement means cooperative with said rolling element.

20. The system of claim 14, wherein said second surface feature comprises rollers.

21. The system of claim 14, further comprising:
a second rolling element joined to said lever, wherein said second rolling element freely rotates.

22. The system of claim 14, wherein said first rolling element remains disengaged from said floor until an operator applies downward force to said first lever section.

23. The system of claim 14, wherein the application of a downward force to said first lever section causes said second lever section to generate an upward force, said upward force being predeterminable according to the lengths of said first and second lever sections, said downward force, said angle, and the positioning of said rolling element,
wherein said angle is substantially and inclusively between 90 degrees and 225 degrees.
